(19) United States
(12) Patent Application Publication
(10) Pub. No.: US 2002/0112785 A1
(43) Pub. Date: Aug. 22, 2002

(54) High energy nanocomposite permanent magnet

(76) Inventors: Shigenobu Sekine, Tokyo (JP); Hiroji Sato, Tokyo (JP); Koichi Niihara, Tokyo (JP); Minoru Narita, Tokyo (JP); Tomohide Takami, Tokyo (JP); Isao Kusunoki, Miyagi (JP)

Correspondence Address: MANELLI DENISON & SELTER, 2000 M STREET NW SUITE 700, WASHINGTON, DC, 20036-3307, US

(21) Appl. No.: 10/020,442

(22) Filed: Dec. 18, 2001

Related U.S. Application Data
(62) Division of application No. 09/632,209, filed on Aug. 3, 2000.

(51) Int. Cl. H01F 1/09

(52) U.S. Cl. 148/302; 419/20

(57) ABSTRACT

A nanocomposite permanent magnet and method of producing same, wherein the magnet includes a complex of:

(1) crystalline RₓFe_{bal}B_{z-δ}M_{δ} or RₓFe_{bal}Co_{y}B_{z-δ}M_{δ} forming grains within the magnet, wherein R is at least one of rare earth elements, M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, y=0-0.3, z=0-0.1 and 8=0-0.01, and wherein Fe, B and R are at least present; and

(2) a non-magnetic rare earth oxide compound which is located at the grain boundaries and within the grains of the crystalline RₓFe_{bal}B_{z-δ}M_{δ} or RₓFe_{bal}Co_{y}B_{z-δ}M_{δ}.

### BACKGROUND OF THE INVENTION

1. Field of the Invention

The present invention relates to a composition for permanent magnet having a controlled nanostructure of amorphous and crystalline components, and a method of making the magnet composition, wherein the magnet has superior magnetic properties.

2. Description of the Prior Art

Materials for permanent magnet are disclosed for example in Japanese patent publication Hei 7-78269 (Japanese patent application Sho58-94876, the patent families include U.S. Pat. Nos. 4,770,723; 4,792,368; 4,840,684; 5,096,512; 5,183,516; 5,194,098; 5,466,308; 5,645,651) disclose (a) RFeB compounds containing R (at least one kind of rare earth element including Y), Fe and B as essential elements and having a tetragonal crystal structure with lattice constants of aₒ about 9 Å and cₒ about 12 Å, and each compound is isolated by non-magnetic phase, and (b) RFeBA compounds containing R, Fe, B and A (Ti, Ni, Bi, V, Nb, Ta, Cr, Mo, W, Mn, Al, Sb, Ge, Sn, Zr, Hf, Cu, S, C, Ca, Mg, Si, O, or P) as essential elements and having a tetragonal crystal structure with lattice constants of aₒ, about 9 Å and cₒ about 12 Å, and each compound is isolated by non-magnetic phase. It is mentioned that the permanent magnet has good properties when (1) the above tetragonal compounds have an appropriate crystal grain size, (2) the compounds are the major phase, and (3) the microstructure of the compounds mixed with the R-rich non-magnetic phase is formed.

According to Example 2 of the Japanese patent publication Hei 7-78269, an alloy of 8 atom % B, 15 atom % Nd and the balance Fe was pulverized to prepare an alloy powder having an average particle size of 3 μm. The powder was compacted in a magnetic field of 10 kOe under a pressure of 2 t/cm² and sintered at 1100° C. for 1 hour in Ar of 2×10⁻¹ Torr. The magnetic properties are: Br=12.1 kG, Hc=9.3 kOe, and (BH)max=34 MGOe. The major phase of the sintered compact is a tetragonal compound with lattice constants of aₒ=8.8 Å and cₒ=12.23 Å. The major phase contains simultaneously Fe, B and Nd, and amounts to 90.5 volume % of the sintered compact. As to the non-magnetic interface phase which isolates the major phase, a non-magnetic phase containing more than 80% of R occupies 4 volume % and the remainder is virtually oxides and pores.

Though this magnet shows excellent magnetic properties, the latent ability of the RFeB or RFeBA tetragonal compounds have not been exhibited fully. This may be due to the fact that the tetragonal compounds are not well-oriented to the cₒ direction since the R-rich phase isolating the major phase of the tetragonal compounds is an amorphous phase.

U.S. Pat. No. 5,942,053 provides a composition for permanent magnet that employs a RFeB system tetragonal tetragonal compounds. This magnet is a complex of (1) a crystalline RFeB or RFeCoB compounds having a tetragonal crystal structure with lattice constants of aₒ about 8.8 Å and cₒ about 12 Å, in which R is at least one of rare earth elements, and (2) a crystalline neodymium oxide having a cubic crystal structure, wherein both crystal grains of (1) and (2) are epitaxially connected and the RFeB or RFeCoB crystal grains are oriented to the cₒ direction. While the resulting magnet has very good magnetic properties, no effort was made to control the nanostructure of the composition and thus the US '053 magnet does not employ the nano-sized and non-magnetic material, rare earth oxide e.g., neodymium oxide, that is incorporated at the inside of the NdFeB ferromagnetic grains and/or at their grain boundaries as in the present invention. The US '053 magnet does not employ the nanostructure consisting of micro-sized ferromagnetic phase and nano-sized nonmagnetic phase resulting in the nanocomposite structure of the present invention that provides superior magnetic properties.

### BRIEF SUMMARY OF THE INVENTION

The present invention provides a composition for a permanent magnet with excellent magnetic properties employing nano-sized, non-magnetic material, which is a rare earth oxide, ROₓ, R₂O₃, RO, (x=1-2) including RO₂, such as neodymium oxide or praseodymium oxide, that is incorporated at the inside of ferromagnetic grains, such as R—Fe—B or R—Fe—Co—B, and/or at their grain boundaries. R is a rare earth element, however, Nd is most preferably employed as R, Pr is more preferably employed and Dy is preferably employed as R. R₂O₃, RO and RO₂ are used as the rare earth oxide in the present invention and Nd₂O₃, NdO and NdO₂ are preferably used in the present invention. The compounds have a tetragonal structure with the lattice constants of aₒ about 8.8 Å and cₒ about 12 Å. This is due to the fact that the lattice constant aₒ of the cubic Nd₂O₃ is about 4.4 Å which is the half length of the lattice constant aₒ about 8.8 Å for the ferromagnetic materials, e.g. RFeB or RFeCoB tetragonal crystal, through which an epitaxial connection is achieved. While having the prescribed tetragonal structure, lattice constants and epitaxial connection, the resulting novel nanostructure consists of micro-sized ferromagnetic phase and novel nano-sized nonmagnetic phase providing for the overall novel nanocomposite structure of the present invention and superior magnetic properties.

### BRIEF DESCRIPTION OF THE DRAWINGS

FIG. 1 shows high resolution TEM image for the amorphous NdOₓ layer located between the Nd₂Fe₁₄B matrix grains NdO, layer located between the Nd₂Fe₁₄B matrix grains.

FIG. 3 shows high resolution TEM image for the crystallized NdOₓ precipitates located between the Nd₂Fe₁₄B matrix grains.

FIG. 4 shows nano-sized NdOₓ particle dispersed at the inside of Nd₂Fe₁₄B matrix grains.

FIG. 5 shows emagnetization curve by the B-H tracer after magnetizing in a pulsed filed of 7 T for the Nd_{1.8}Pr_{0.2}Fe₁₁Co₃B_{0.97}M_{0.03}—NdOₓ (x=1, 1.5, or 2) nanocomposite magnet.

FIG. 6 shows magnetization curve by the VSM method in the magnetic field up to 20 T.

FIG. 7 shows weight increase by oxidation at 500° C. in O₂ atmosphere for the Nd_{1.8}Pr_{0.2}Fe₁₁Co₃B_{0.97}M_{0.03}—NdOₓ (x=1, 1.5, or 2) nanocomposite magnet.

FIG. 8. shows a transmission electron microscopic (TEM) image showing the existence of an amorphous layer (indicated “A” in the figure) between the grain boundaries of the Nd₂Fe₁₄B phase (lower) and the neodimium oxide phase (upper).

FIG. 9. shows a energy dispersive X-ray (EDX) spectrum of the oxide phase located at the grain boundaries. Chemical composition obtained from this spectrum: 0-38.8 at %, Nd-31.4 at %, Fe-14.2 at %, Pr-6.7 at %, Co-4.6 at %, Ga-2.6 at %, Zn-1.6 at %, La-0.1 at %.

FIG. 10. shows a transmission electron microscopic (TEM) image showing small particles of the neodimium oxide phases inside the Nd₂Fe₁₄B phase, a,b: particles of metastable oxide phase, c-f: particle of monocrystalline oxide phases.

FIG. 11. shows a schematic of the sintering and crystallization process.

FIG. 12. shows EDX spectra of microcrystalline, metastable, oxygen phases.

### DETAILED DESCRIPTION OF THE INVENTION

A strong permanent magnet, with the maximum magnetic energy (BH)ₘₐₓ corresponding to the theoretical value (64 MGOe) for a rare earth R—Fe—B single crystal such as Nd₂Fe₁₄B, was developed by controlling the nanostructure through in-situ reaction during sintering. In this process, “oxygen”, which is conventionally avoided as an impurity in magnetic materials, was positively introduced as a reforming agent in a form of metal oxide. Consequently, in the case of Nd₂Fe₁₄B, the nano-sized and non-magnetic material, neodymium oxide, was novelly incorporated at the inside of the Nd₂ Fe₁₄B ferromagnetic grains and/or at their grain boundaries. This nanostructure, consisting of micro-sized ferromagnetic phase and nano-sized nonmagnetic phase, is a nanocomposite structure, which has been employed in the structural ceramic-based composite materials. The nanocomposite structure also improves the mechanical properties of the magnet, providing for improved superplasticity and machinability. Thus, the present invention is useful in various audio devices, electric motors, generators, meters and medical equipment, computer, telecommunication systems and other scientific apparatus, and in the development of devices for micromachines which demand magnets of outstanding magnetic characteristics and reliability.

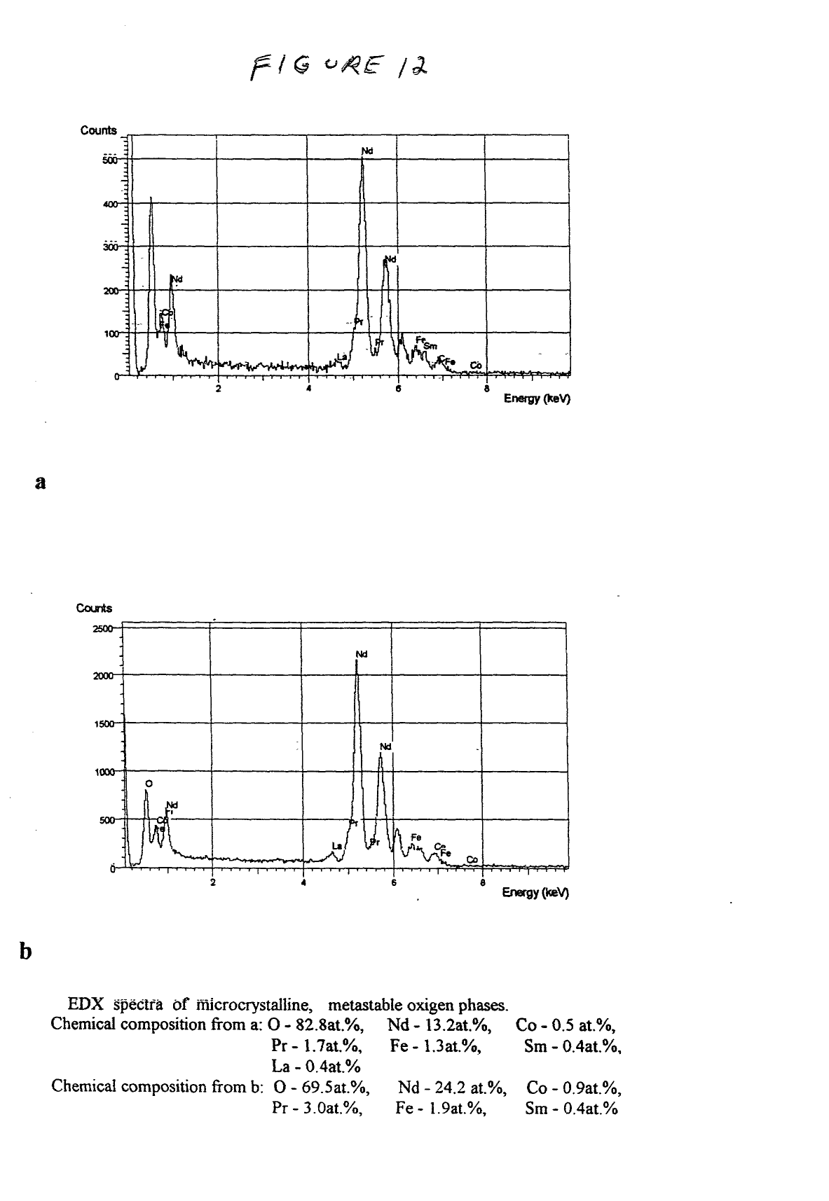

In general, the present RFeB or RFeCoB permanent magnet composition is prepared by providing an alloy of predetermined composition, pulverizing the alloy in an inert gas atmosphere for prevention of oxidation, compacting the alloy powder under a magnetic field, and performing a first sintering operation on the compacted powder in an inert gas followed by vacuum, and then a second sintering operation on the first sintered powder, in an inert gas followed by vacuum. An important factor in obtaining the composition according to the present invention is controlling the amount of oxygen in the complex during both sintering steps. The RFeB alloys or RFeCoB alloys having predetermined compositions for magnets, or such R containing raw material composing a part of the alloy components as Nd, Nd—Fe or Nd—Fe—Co metals are crushed, the crushed raw material is mixed with crushed zinc (or silicates) in an inactive organic solvent, preferably toluene, containing a small amount of water within an inert gas containing a small amount of oxygen, pulverizing the mixture by wet process to obtain finely pulverized particles having average diameter of 1-100 μm. Then, if necessary, additional metal powder is placed into the solvent to compensate the deficient component for predetermined composition, and further pulverized as necessary. The crushed powder is dried in a non-reactive gas stream and heated. The heated powder is compacted in a magnetic field in an ordinary way, and undergoes two sintering steps to obtain the permanent magnet having a nanocomposite structure. The zinc acts not only as a size controller of RFeB or RFeCoB compounds and Nd oxide particles in the sintering process but also as a surfactant to connect the RFeB or RFeCoB compounds with Nd oxide grains. The zinc evaporates during the first sintering step and virtually none remains in the composition. A schematic of the process that results in the nanocomposite magnet of the present invention is shown in FIG. 11.

The RFeB and RFeCoB of the present nanocomposite magnet is crystalline RFeB or RFeCoB, and the rare earth (eg. neodymium) oxide is also crystalline. The rare earth oxide crystalline compound is a nano-crystalline agglomerate or a single crystal. The RFeB or RFeCoB and the rare earth oxide are epitaxially connected. Such epitaxial connection is obtained by crystalline rare earth oxide grains formed by oxidation of the rare earth within the RFeB or RFeCoB raw material. The present nanocomposite magnet includes a complex of a crystalline RFeCoB (or RFeB) compound having a tetragonal crystal structure with lattice constants of aₒ about 8.8 Å and cₒ about 12 Å, in which R is at least one of rare earth elements, and a crystalline rare earth (eg. Nd) oxide having a cubic crystal structure, wherein both crystal grains of the crystalline RFeCoB (or RFeB) compound and crystalline rare earth oxide are epitaxially connected and the RFeCoB (or RFeB) crystal grains are oriented to the co direction.

In the prior art, rare earth oxide may be added to a mixture to form a magnet, but the rare earth oxide does not melt during the sintering and exists as a foreign object without establishment of epitaxial connection with other components.

In the present process of forming the nanocompsite magnet, the Zn acts as a catalyst to oxidize R to form R-oxide cubic crystals of R₂O₃ and ROₓ, x=1, 1.5 or 2, in epitaxial connection with the tetragonal crystals of RFeB or RFeCoB. As noted above, the zinc acts not only as a size controller of RFeB or RFeCoB compounds and Nd oxide particles on the sintering process but also as a surfactant to connect the RFeB or RFeCoB compounds with Nd oxide grains epitaxially. The zinc evaporates during the sintering and hardly remains in the nanocomposite composition.

Thus, during the first sintering step, R in the surface layer of RFeCoB (or RFeB) reacts with Zn/ZnO to form ROₓ and free Zn. The ROₓ is formed on the surface layer of RFeCoB and makes epitaxial connection with the underlying RFeCoB crystal grains, and the freed Zn evaporates. The formed ROₓ covers the overall surface of RFeCoB. This means that the oxidation of the product does not proceed further. The oxidation by ZnO is a moderate one, and only R in the surface layer of RFeCoB is oxidized. In the present magnet, magnetic RFeCoB crystal grains align toward one direction. Alignment of magnetic crystal grains contributes to enforce the magnetic properties. Additionally, the product of the first sintering step has smaller, non-magnetic rare earth particles that plug and fill into the voids between the larger particles of the magnetic RFeCoB or RFeB domain, and the magnetic domains are surrounded by rare earth non-magnetic domains with epitaxial connection.

Due to the second sintering step, the introduced rare earth oxide is nano-sized and non-magnetic, and is incorporated at the inside of the RFeB ferromagneticgrains and/or at their grain boundaries. The resulting grain boundry is composed of amorphous and/or nonocrystalline rare earth oxide phases, and there are intragranular crystalline rare earth oxide dispersions within the matrix RFeB (or RFeCoB) grains. The intragranular crystalline rare earth oxide dispersions are from approximately 10 to 100 nm in diameter, within the matrix grains.

In the nanocomposite magnet of the present invention, the matrix of the composition is a rare earth-ferromagnetic material, typically a RFeB or RFeCoB system. R is one or more of the rare earth elements, including La, Ce, Pr, Nd, Pm, Sm, Eu, Gd, Tb, Dy, Ho, Er, Tm, Yb and Lu.

In several embodiments of the present invention, the ferromagnetic composition includes RₓFe_{bal}B_{z-δ}M_{δ}, RₓFe_{bal}Co_{y}B_{z-δ}M_{δ}, R¹_{x-α}R²_{α}Fe_{bal}B_{z-δ}M_{δ} and R¹_{x-α}R²_{α}Fe_{bal}Co_{y}B_{z-δ}M_{δ} (and may further include a third rare earth metal, R³_{β} that is to say, R¹_{x-α-β}R²_{α}R³_{β}Fe_{bal}B_{z-δ}M_{δ} or R¹_{x-α-β}R²_{α}R³_{β}Fe_{bal}Co_{y}B_{z-δ}M_{δ}) where M is minor metal elements (M=Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V), x=0-0.3, α=0-0.1, β=0-0.1, y=0-0.3, z=0-0.1, and δ=0-0.01 (with the caveat that Fe, B and at least one R are always present in the composition). Preferred composition embodiments have the same formulas as the forgoing formulas with, however, x=0.3 and z=0.1. As a starting material, this composition may be in several shapes, including a flake-like shape and it is prepared using constituent elements under an Ar (alternatively N, H, He or metal vapor) atmosphere. An example of this composition containing three rare earth elements is Nd_{x-α-β}Pr_{α}Dy_{β}Fe_{bal}Co_{y}B_{z-δ}Al_{δ} where x=0-0.3, α=0-0.1, β=0-0.1, y=0-0.3, z=0-0.1, and δ=0-0.01 (Fe, B and one rare earth metal are always present). A preferred composition embodiment has the same formula as the forgoing formula with, however, x=0.3 and z=0.1.

Thus, the present invention includes but is not limited to the following embodiments;

1. A nanocomposite permanent magnet comprising a complex of:

(1) crystalline RₓFe_{bal}B_{z-δ}M_{δ} or RₓFe_{bal}Co_{y}B_{z-δ}M_{δ} forming grains within the magnet, wherein R is at least one of rare earth elements, M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, y=0-0.3, z=0-0.1 and δ=0-0.01, and wherein Fe, B and R are at least present; and

(2) a non-magnetic rare earth oxide compound which is located at the grain boundaries and within the grains of the crystalline RₓFe_{bal}B_{z-δ}M_{δ} or RₓFe_{bal}Co_{y}B_{z-δ}M_{δ}.

2. The nanocomposite magnet of above 1, wherein x=0.3 and z=0.1.

3. The nanocomposite magnet of above 1, wherein the grain boundry is composed of amorphous and/or nonocrystalline rare earth oxide phases, and intragranular crystalline rare earth oxide dispersions within the matrix grains

4. The nanocomposite magnet of above 1 wherein the RₓFe_{bal}B_{z-δ}M_{δ} or RₓFe_{bal}Co_{y}B_{z-δ}M_{δ} is a crystalline compound having a tetragonal crystal structure with lattice constants of aₒ about 8.8 Å and cₒ about 12 Å, in which R is at least one of rare earth elements, and

the rare earth oxide is a crystalline compound having a cubic crystal structure, wherein both crystal grains of the RₓFe_{bal}B_{z-δ}M_{δ} or RₓFe_{bal}Co_{y}B_{z-δ}M_{δ} and the rare earth oxide are epitaxially connected and the RₓFe_{bal}B_{z-δ}M_{δ} or RₓFe_{bal}Co_{y}B_{z-δ}M_{δ} crystal grains are oriented to the co direction.

5. The nanocomposite magent of above 1 wherein R is selected from the group consisting of La, Ce, Pr, Nd, Pm, Sm, Eu, Gd, Tb, Dy, Ho, Er, Tm, Yb and Lu.

6. The nanocomposite magent of above 1 wherein R is Nd.

7. The nanocomposite magent of above 1, wherein the rare earth oxide is one of ROₓ wherein x=1-2, R₂O₃, or RO.

8. The nanocomposite magnet of above 2, wherein the volumetric ratio of the cubic crystalline neodymium oxide to the tetragonal crystalline RFeB or RFeCoB is 1-45%.

9. The nanocomposite permanent magnet of above 2 wherein the rare earth oxide crystalline compound is a nano-crystalline agglomerate or a single crystal.

10. A nanocomposite permanent magnet comprising a complex of:

(1) crystalline R¹_{x-α}R²_{α}Fe_{bal}B_{z-δ}M_{δ} wherein R is at least one of rare earth elements and M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, α=0-0.1, z=0-0.1, and wherein at least Fe, B and at least one R are present and δ=0-0.01; and

(2) a non-magnetic rare earth oxide compound which is located at the grain boundaries and within the grains of the crystalline R¹_{x-α}R²_{α}Fe_{bal}B_{z-δ}M_{δ}.

11. A nanocomposite permanent magnet comprising a complex of:

(1) crystalline R¹_{x-α}R²_{α}Fe_{bal}Co_{y}B_{z-δ}M_{δ} wherein R is at least one of rare earth elements and M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, α=0-0.1, y=0-0.3, z=0-0.1, and δ=0-0.01, and wherein at least Fe, B and at least one R are present; and

(2) a non-magnetic rare earth oxide compound which is located at the grain boundaries and within the grains of the crystalline R¹_{x-α}R²_{α}Fe_{bal}Co_{y}B_{z-δ}M_{δ}.

12. A nanocomposite permanent magnet comprising a complex of:

(1) crystalline R¹_{x-α-β}R²_{α}R³_{β}Fe_{bal}B_{z-δ}M_{δ} wherein R is at least one of rare earth elements and M is selected from the group consisting of Ba, Ca, Mg, Sr, Be, Bi, Cd, Co, Ga, Ge, Hf, in, Al, Si, Mn, Mo, Re, Se, Ta, Nb, Te, Tl, Ti, W, Zr and V, wherein x=0-0.3, α=0-0.1, β=0-0.1, z=0-0.1 and δ=0-0.01, and wherein at least Fe, B and at least one R are present; and

(2) a non-magnetic rare earth oxide compound which is located at the grain boundaries and within the grains of the crystalline

13. A nanocomposite permanent magnet comprising a complex of:

(1) crystalline R¹_{x-α-β}R²_{α}R³_{β}Fe_{bal}Co_{y}B_{z-δ}M_{δ} wherein R is at least one of rare earth elements and M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, α=0-0.1, β=0-0.1 y=0-0.3, z=0-0.1 and δ=0-0.01; and

(2) a non-magnetic rare earth oxide compound which is located at the grain boundaries and within the grains of the crystalline R¹_{x-α-β}R²_{α}R³_{β}Fe_{bal}Co_{y}B_{z-δ}M_{δ}.

In preparing the composition of the present invention, to obtain localized precipitation of R oxide (ROₓ, x=1.0 to 2.0), e.g., Nd oxide (NdOₓ, x=1.0 to 2.0) fine ZnO (alternatively silicates, generally SiO₂, SiO₃, SiO₄, Si₂O₇, Si₃O₁₀, and one or more metals with or without H) powder (0.1 to 0.5 wt %) with an average size of 100 nm and range of 5 nm to 500 nm, are mixed with the raw ferromagnetic materials when they are pulverized, such as by ball milling, in toluene, or other in active organic solvent, using ZnO balls (alternatively, Fe, Co and/or Ga oxide balls) of less than 0.1 mm in diameter. The obtained mixture powders have an average particle size of 2.5 μm, and ranging from 1 μm to 5 μm, are aligned in the magnetic field of 2 to 7 T and pressed perpendicular to the aligned direction at a pressure of 4 to 12 Mpa and preferably 8 MPa.

The resulting compacts, generally in block form, are heat-treated and undergo a first sintering step at 900 to 1100° C., first in vacuum for 1-5 hours, preferably 3 hours and then in Ar gas (or N, H, He or metal vapor gas) for 2-8 hours, preferably 5 hours and cooled. The first sintered samples undergo a second sintering step at 300 to 1000° C. first in Ar gas for 1-3 hours (preferably 1 hour) and then in a vacuum for 2-8 hours (preferably 5 hours), and then cooled rapidly. The second sintering step produces a grain boundary composed of amorphous and/or nonocrystalline rare earth oxide phases, and intragranular crystalline rare earth oxide dispersions within the matrix grains.

The temperature of the sintered specimens is between 800-1,050° C. and preferably, 1,000° C. The Curie temperature can be measured using a vibrating-sample magnetometer (VSM). A magnetic field of 2-7 T and preferably about 2 T is applied to the sintered specimen parallel to its magnetically oriented direction. The magnetic properties of the sintered magnets is estimated from the demagnetization curves measured by the B-H curve after magnetizing in a pulsed field of 4-10 T and preferably at 7 T.

Thus, the method of the present invention can be succinctly described, but is not limited to the following:

A method for preparing a nanocomposite permanent magnet including a complex of

(1) crystalline RₓFe_{bal}B_{z-δ}M_{δ} or RₓFe_{bal}Co_{y}B_{z-δ}M_{δ} wherein R is at least one of rare earth elements, M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, y=0-0.3, z=0-0.1 and δ=0-0.01, wherein at least Fe, B and R are present (preferred composition embodiments have the same formulas as the forgoing formulas with, however, x=0.3 and z=0.1); and

(2) a non-magnetic rare earth oxide compound which is located at the grain boundaries and within the grains of the crystalline RₓFe_{bal}B_{z-δ}M_{δ} or RₓFe_{bal}Co_{y}B_{z-δ}M_{δ}, comprising the following steps:

mixing precursor, selected from the group consisting of RₓFe_{bal}B_{z-δ}M_{δ} powder and RₓFe_{bal}Co_{y}B_{z-δ}M_{δ} powder, with Zn powder in an organic solvent;

crushing the mixed powders in the solvent under an inert gas atmosphere containing up to 1 volume percent oxygen;

drying the crushed powders in an inert gas;

compacting the dried powders under a magnetic field;

performing a first sintering step wherein the compacted powder is sintered and the Zn is evaporated under pressure in an inert gas, and then allowing the compact to cool, said Zn acting as a catalyst to oxidize R to form R-oxide cubic crystals of R₂O₃ and ROₓ, x=1-2, in epitaxial connection with the tetragonal crystals of RₓFe_{bal}B_{z-δ}M_{δ} or RₓFe_{bal}Co_{y}B_{z-δ}M_{δ}; and performing a second sintering step to produce a grain boundry composed of amorphous and/or nonocrystalline rare earth oxide phases, and intragranular crystalline rare earth oxide dispersions within the matrix grains.

Additionally, the Zn compound in the above can be replaced by a silicate.

Constituents and effects of the present invention will be described in the following example, however, the present invention is not to be limited in any way to the example. For instance, additional compounds with different stoichiometric ratios of R:Fe:B or R:Fe:Co:B are employed. Such RFeB compounds that contain various additives are within the purview of the invention. For the R oxide, NdOₓ is preferred, but other oxides such as NdO and Nd₂O₃ may also be employed.

In the following Example, the nanocomposite magnet of the present invention has the general formula of Nd_{-α}Pr_{α}Fe_{bal}Co_{y}B_{z-δ}M_{δ}; M: minor metal elements, x=0-0.3, α=0-0.1, y=0-0.3, z=0-0.1 and δ=0-0.01, and wherein at least Fe, B and at least one rare earth are present (a preferred composition embodiment has the same formula as the forgoing formula with, however, x=0.3 and z=0.1). However, the present nanocomposite magnet may have such stoichiometric ratios as 28Nd55Fe15Co3.0B wt %, 4Pr26.0Nd52.3Fe17Co0.7B wt % and 15Nd67.0Fe15Co3.0B wt %.

### EXAMPLE 1

Flake-like ferromagnetic raw materials (Nd_{x-α}Pr_{α}Fe_{bal}Co_{y}B_{z-δ}M_{δ}; M is minor metal elements, x=0.3, α=0-0.1, y=0-0.3, z=0.1 and δ=0-0.01, and wherein at least Fe, B and at least one rare earth are present) were prepared by strip casting constituent elements under an Ar atmosphere. The purities of is Nd, Pr, Fe, Co and B were 99.0, 99.2, 99.9, 99.9 and 99.0 wt %, respectively. For the localized precipitation of neodymium oxide (NdOₓ, x=1.0 to 1.5), fine ZnO powder (0.1 to 0.5 wt %) with an average size of 100 nm was mixed with the raw ferromagnetic materials during pulverization by ball milling technique in toluene. The ball milling employed ZnO balls of 5 mm in diameter. The obtained mixture of powders had powder of an average particle size 2.5 μm. The mixture of powders were aligned in a magnetic field of 1.59 MA/m (2 T) and pressed perpendicular to the aligned direction at a pressure of 8 MPa. This resulted in green compacts, 50×40×30 mm blocks, which were heat-treated and sintered at 900 to 1100° C. first in vacuum for 3 hours and then in Ar gas for 5 hours. The first sintered samples were again sintered in a post-annealing step at 300 to 1000° C., and then cooled rapidly.

The Curie temperature of the sintered specimens was estimated using vibrating-sample magnetometer (VSM). A magnetic field of 1.59 MA/m (2 T) was applied to the sintered specimens parallel to its magnetically oriented direction. The magnetic properties of the sintered magnets were estimated from the demagnetization curves measured by the B-H tracer after magnetizing in a pulsed filed of 5.57 MA/m (7 T).

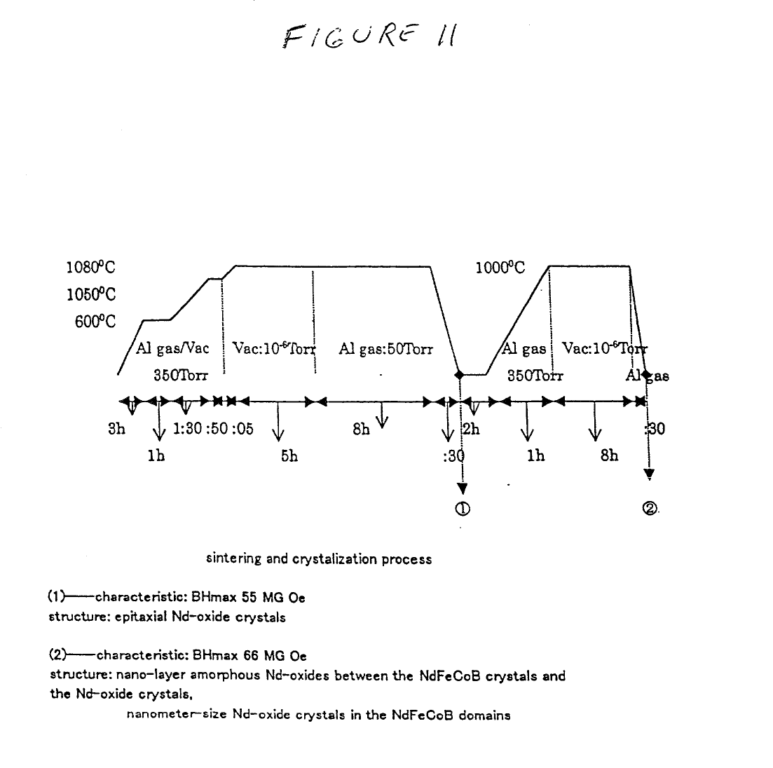

The specimens of 10×10×10 mm blocks were used for this measurement. The magnetic properties of the sintered magnets were also estimated by the VSM method using the spherical specimens of 4 mm diameter in the extremely high magnetic field up to 15.9 MA/m (20 T) at the National High Magnetic Field Laboratory, Tallahassee Fla. Ni metal (ASTM Standard A 894089) was used as the standard sample for calibration in the above-mentioned magnetic measurements. The phase identification was performed by X-ray diffraction analyses. The micro/nano structure was mainly investigated by high resolution transmission electron microscopy (TEM) and energy dispersive X-ray spectroscopy (EDX). The TEM results are shown in FIG. 10. The EDX results are shown in FIG. 12. Vickers hardness and 3-point bending strength as well as oxidation resistance were measured by the conventional methods.

The density of sintered magnet was changed from 7.56 to 7.68 g/cm³ depending on the composition and sintering conditions. The average grain size of ferromagnetic Nd₂Fe₁₄B phase was approximately 10 μm. The X-ray diffraction analyses revealed that the sintered samples were mainly composed of tetragonal Nd₂Fe₁₄B and cubic Nd₂O₃ phases, indicating the trace of nonmagnetic NdFe₄B₄ phase.

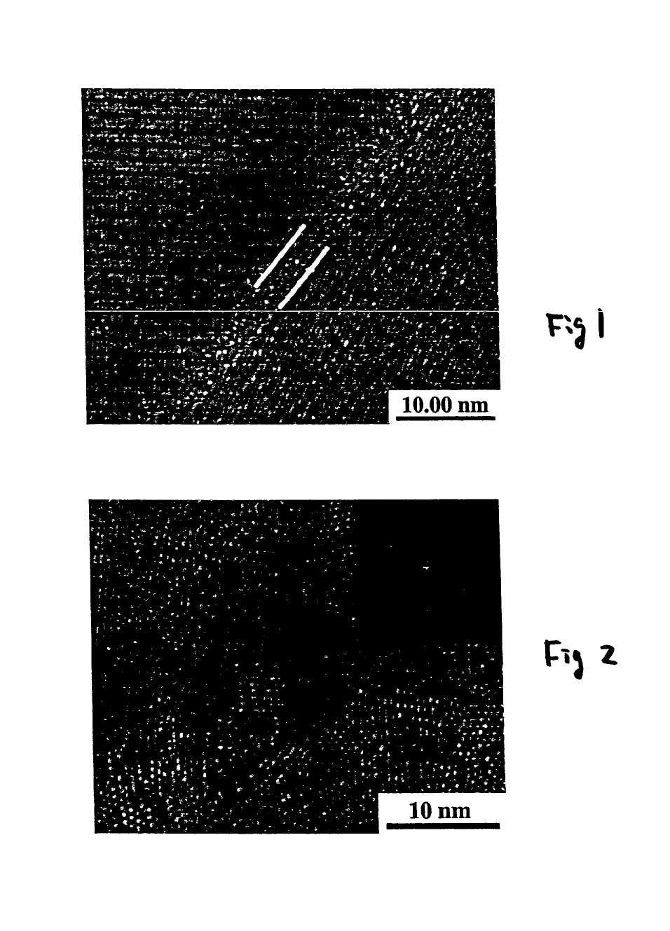

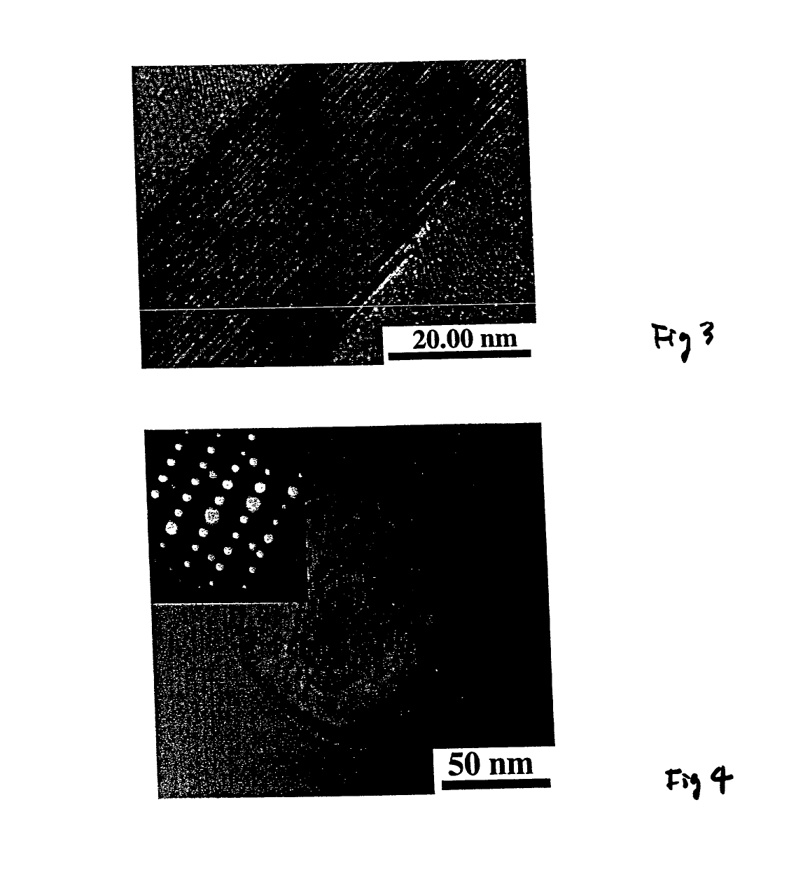

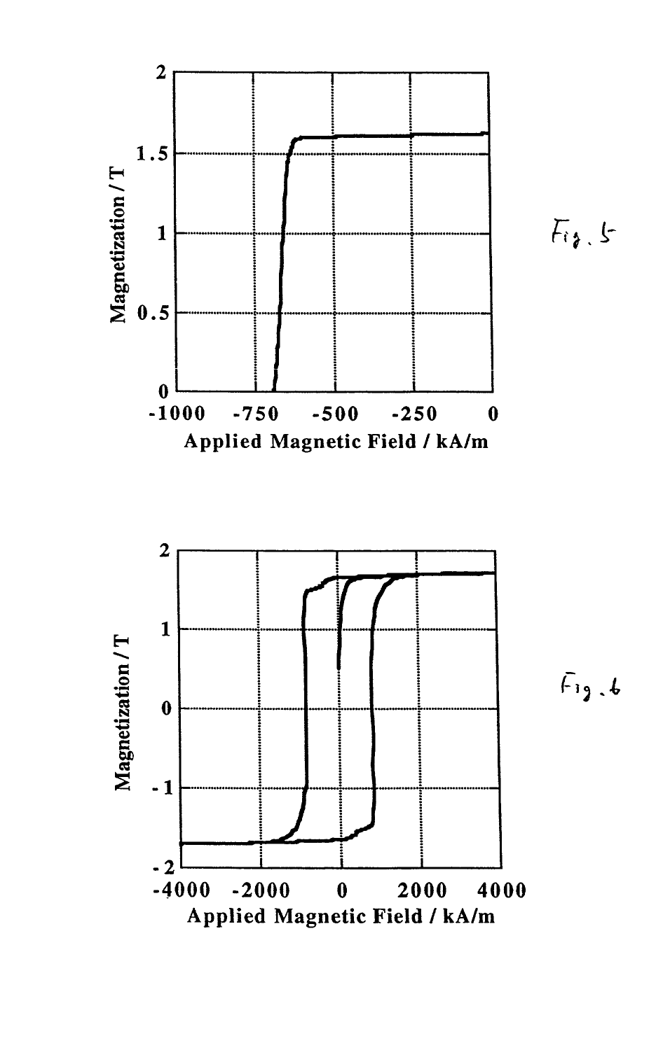

The TEM observation with EDX analyzer showed that the NdOₓ (x=1.3 to 1.5) including the trace of Fe and Co was located at the grain boundaries and/or at the inside of the matrix grains. As can be seen in FIGS. 1 to 3, the grain boundary was composed of the amorphous and/or nanocrystalline NdOₓ phases. These grain boundary NdOₓ materials were partially crystallized together with the decrease of Zn content by the longer heat-treatment at higher temperatures as shown in FIG. 4. The intragranular crystalline NdOₓ dispersions from approximately 10 to 100 nm in diameter was also identified within the matrix grains, as indicated in FIG. 4.

It is believed that ZnO is decomposed to Zn and O₂ even in air at 800 to 1200° C. according to the following equilibrium equation,

ZnO(s)⇄Zn(g)+½O₂ (1)

Thus, the formation of NdOₓ identified for the sintered nanocomposite magnets could be attributed to the preferential surface chemical reaction of oxygen from ZnO with the Nd₂Fe₁₄B powder in the sintering temperature range of 900 to 1100° C. The Zn metal through this reaction should be gradually sublimated during sintering, and resulting in virtually no remaining Zn.

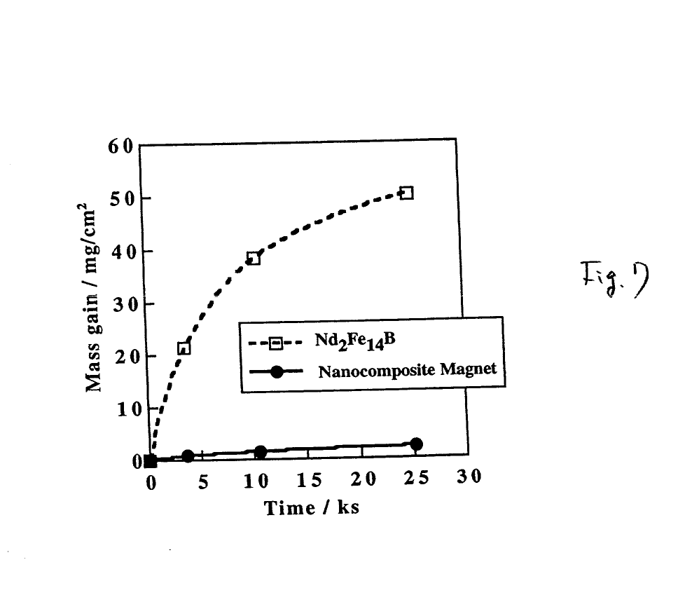

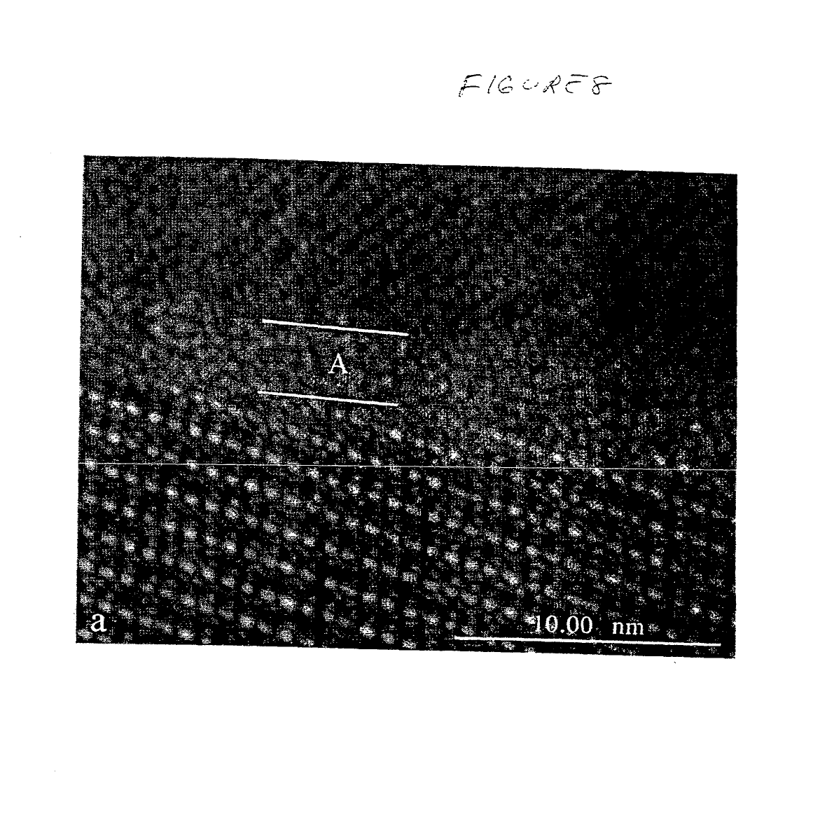

FIG. 5 shows the second quadrant demagnetization curve for the Nd_{1.8}Pr_{0.2}Fe₁₁Co₃B_{0 97}M_{0.03}—NdOₓ (where x=1, 1.5 or 2), nanocomposite magnet (reference no.=NSK 60) pulse-magnetized at 5.57 MA/m (7 T). The magnetic hysteresis loop of this magnet were also evaluated by the VSM method in the high magnetic field up to 1.59 MA/m (20 T), as shown in FIG. 6. An important difference between these measurements is the slight deflection in the upper curve. These deflections are predicted for the nanocomposite magnet consisting of the magnetically hard and soft phases. The curve deflections observed for the present nanocomposite magnet with the completely different nanocomposite structure may be attributed to the applied magnetic field direction non-parallel to the magnetic easy axis and/or specimen geometry.

As shown in FIG. 7, the oxidation resistance of the present magnet was confirmed to be superior to the commercial Nd₂Fe₁₄B magnets. As expected from the nanostructure with the NdOₓ layer at the Nd₂Fe₁₄B grain boundary, the oxidation rate of the nanocomposite, which was 1/24 times than that for the commercial Nd₂Fe₁₄B magnet. The oxidation rate was estimated by the weight increase due to the Fe₂O₃ based oxides layer formed at 500° C. for 7 hours in O₂ atmosphere. The Vickers hardness and fracture strength of Nd_{1.8}Pr_{0.2}Fe₁₁Co₃B_{0.97}Al_{0.03}—NdO₁₋₂ nanocomposite magnet of the present invention were 7.1 GPa and 33 OMPa, respectively. These values are much higher than 6 GPa and 245 MPa for the conventional Nd₂Fe₁₄B based magnets.

The important properties of the present magnet are summarized in Table 1, including the new data reported as the world record for the Nd₂Fe₁₄B based magnet. From this Table, it is clear that the magnetic properties of the present magnet have high values for the (BH)ₘₐₓ and Curie temperature. The (BH)ₘₐₓ value of the present magnet is almost equal to or a little higher than the theoretical value (64 MGOe) for the Nd₂Fe₁₄B single crystal. The Curie temperature is also high, indicating the excellent temperature coefficient of magnetic properties. In order to achieve a high energy product (BH)ₘₐₓ value of the Nd₂Fe₁₄B based sintered magnets, the following four factors are very important: 1) the optimization of composition, 2) the small and narrow grain size distribution, 3) the higher degree of crystal alignment and 4) the decrease of oxygen content. The last factor is believed to be especially important. The magnetic properties of the present magnet are superior to the conventional NdFeB based magnets.

As above mentioned, however, the nonmagnetic NdOₓ is intentionally incorporated intra- and intergranularly in the present magnets. Based on the information from the ceramic/ceramic nanocomposites, particularly for Al₂O₃/SiC and MgO/SiC composite systems, the highly localized residual stresses caused by thermal expansion mismatch between two phases must exist around the NdOₓ located at the inside of the Nd₂Fe₁₄B gains and/or at the grain boundary. This localized stress will plays an important role in improving the magnetic properties of the present magnets.

TABLE 1
Magnetic properties of newly developed
Nd_{1.8}Pr_{0.2}Fe₁₁Co₃B_{0.97}M_{0.03}—NdOₓ (where x = 1-2)

nanocomposite of the present invention

| | Br | ᵢH_{c} | (BH)ₘₐₓ | | Curie Temp. |
|---|---|---|---|---|---|
| Sample | (Tesla) | (A/m) | (kJ/m³) | (MGOe) | (° C.) |
| Present* | 1.665 | 805 | 551 | 66.3 | 550° C. |
| invention | | | | | |
| (at 20 T) | | | | | |
| Nd₂Fe₁₄B | 1.514 | 691 | 4.44 | 55.8 | 330° C. |

*Estimated by the VSM method in the magnetic field up to 20 T

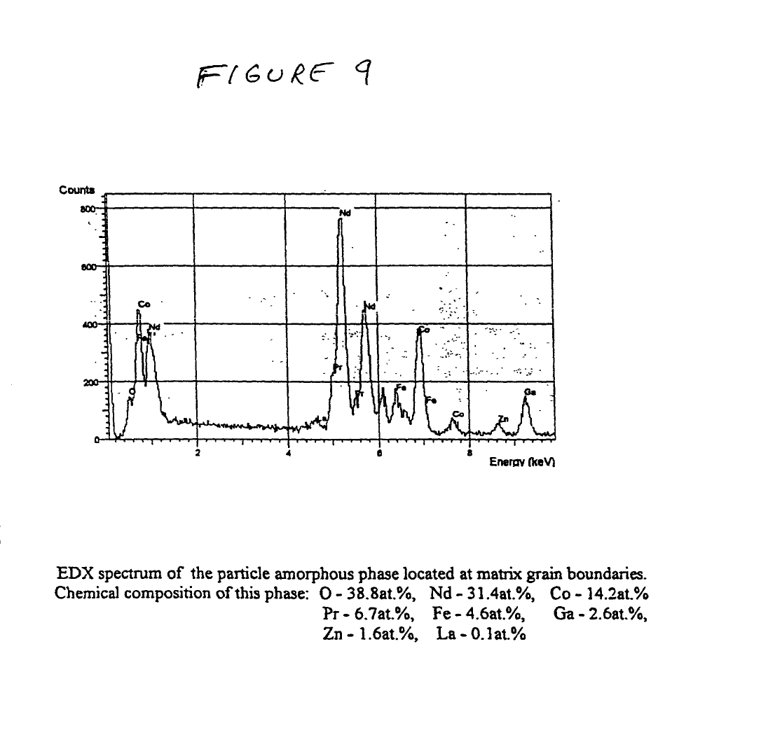

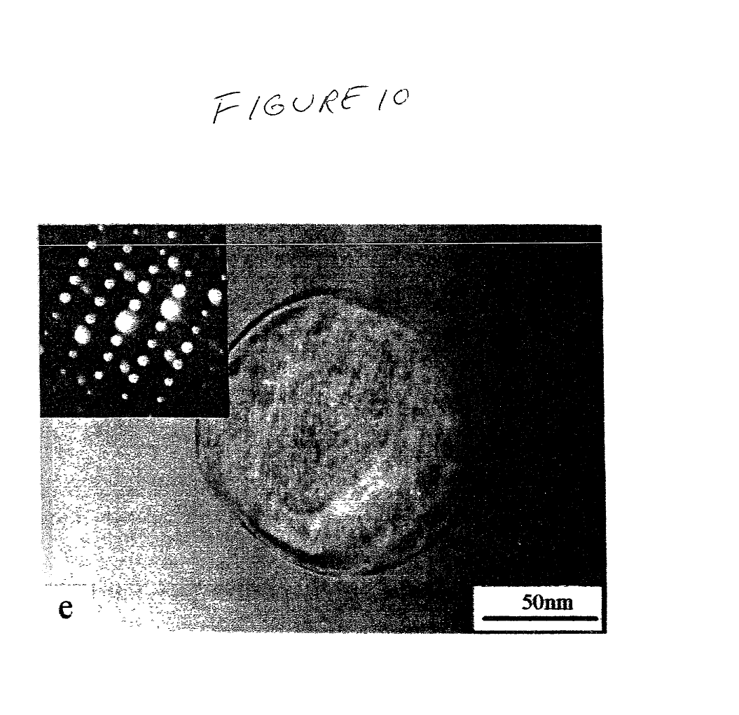

Thus, in the magnet of the present invention, the main crystalline phase of the RFeB or RFeCoB compound and the crystalline neodymium oxide are not directly connected but connected with a buffer layer of an amorphous neodymium oxide. FIG. 8 shows an example of the connection between the Nd₂Fe₁₄B crystalline phase (lower in the figure) and the neodymium oxide crystalline phase (upper in the figure) via an amorphous layer (indicated “A” in the figure). The composition of the amorphous layer was observed by energy dispersive X-ray (EDX) spectroscopy. FIG. 9 shows the EDX spectrum, which indicates that the amorphous layer is mainly consists of neodymium oxide.

In the present magnet, the main crystalline phase of the RFeB or RFeCoB includes the crystalline neodymium oxide with a grain size between 5-100 nm. FIG. 10 shows examples of the structure; nano-crystalline particles of the neodymium oxide inside the Nd₂Fe₁₄B crystalline phase. FIGS. 10a and b show the particles being metastable, having the structure between an amorphous and a crystalline phase, neodymium oxide inside the Nd₂Fe₁₄B crystalline, and FIGS. 10c, d, e, f show the particles of monocrystalline neodymium oxide inside the Nd₂Fe₁₄B crystalline. The diffraction patterns shown in the upper left of each FIGS. 10a-f indicate the structure of the neodymium oxides.

### PRECURSOR SAMPLES 2, 3 AND 4

The following samples were produced by performing the first sintering step in producing the present nanocomposite magnet. The precursor would be subjected to the second sintering step, as in the above Example 1, to produce the final nanocomposite product having a grain boundry composed of amorphous and/or nonocrystalline rare earth oxide phases, and intragranular crystalline rare earth oxide dispersions within the matrix grains.

Precursor Samples No. 2,No. 3 and No. 4 were prepared according to the method of the present invention:

One hundred weight parts raw material powder were employed having basically a crystal structure of Nd₂Fe₁₄B (atomic %), which was tested as Sample No. 2. In this sample, a part of Fe was substituted with Co and a part of Nd was substituted with Pr, and 1 weight part Zn powder were mixed and crushed in toluene containing 100 ppm water under Ar gas atmosphere containing 1 volume-% oxygen. The resulting powder had an average particle size of 2 μm was dried under an Ar gas stream containing no oxygen gas. The dried powder was compacted at 2t/cm² under a magnetic field of 30 kOe, and the compact was sintered at 1,080° C. for an hour in Ar gas at 1.5 Torr to obtain a permanent magnet. Sample No. 2 has the following crystal structure: 28Nd55Fe15Co1B (Wt %). The above method further resulted in Sample 3 and Sample 4 having the following crystal structure:

Sample No. 3 was 4Pr26.0Nd52.3Fe17Co0.7B (Wt %); and Sample No. 4 was 15Nd67.0Fe15Co3.0B (Wt %).

What is claimed is:

1. A nanocomposite permanent magnet comprising a complex of:
(1) crystalline RₓFe_{bal}B_{z-δ}M_{δ} or RₓFe_{bal}Co_{y}B_{z-δ}M_{δ} forming grains within the magnet, wherein R is at least one of rare earth elements, M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, y=0-0.3, z=0-0.1 and δ=0-0.01, and wherein Fe, B and R are at least present; and
(2) a non-magnetic rare earth oxide compound which is located at the grain boundaries and within the grains of the crystalline RₓFe_{bal}B_{z-δ}M_{δ} or RₓFe_{bal}Co_{y}B_{z-δ}M_{δ}.

2. The nanocomposite magnet of claim 1, wherein x=0.3 and z=0.1.

3. The nanocomposite magnet of claim 1, wherein the grain boundry is composed of amorphous and/or nonocrystalline rare earth oxide phases, and intragranular crystalline rare earth oxide dispersions within the matrix grains

4. The nanocomposite magnet of claim 1 wherein the RₓFe_{bal}B_{z-δ}M_{δ} or RₓFe_{bal}Co_{y}B_{z-δ}M_{δ} is a crystalline compound having a tetragonal crystal structure with lattice constants of aₒ about 8.8 Å and cₒ about 12 Å, in which R is at least one of rare earth elements, and the rare earth oxide is a crystalline compound having a cubic crystal structure, wherein both crystal grains of the RₓFe_{bal}B_{z-δ}M_{δ} or RₓFe_{bal}Co_{y}B_{z-δ}M_{δ} and the rare earth oxide are epitaxially connected and the RₓFe_{bal}B_{z-δ}M_{δ} or RₓFe_{bal}Co_{y}B_{z-δM}_{δ} crystal grains are oriented to the co direction.

5. The nanocomposite magent of claim 1 wherein R is selected from the group consisting of La, Ce, Pr, Nd, Pm, Sm, Eu, Gd, Tb, Dy, Ho, Er, Tm, Yb and Lu.

6. The nanocomposite magent of claim 1 wherein R is Nd.

7. The nanocomposite magent of claim 1, wherein the rare earth oxide is one of ROₓ wherein x=1-2, R₂O₃, or RO.

8. The nanocomposite magnet of claim 3, wherein the volumetric ratio of the cubic crystalline neodymium oxide to the tetragonal crystalline RFeB or RFeCoB is 145%.

9. The nanocomposite permanent magnet of claim 3 wherein the rare earth oxide crystalline compound is a nano-crystalline agglomerate or a single crystal.

10. A nanocomposite permanent magnet comprising a complex of:
(1) crystalline R¹_{x-α}R²_{α}Fe_{bal}B_{z-δ}M_{δ} wherein R is at least one of rare earth elements and M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, α=0-0.1, z=0-0.1, and wherein at least Fe, B and at least one R are present and δ=0-0.01; and
(2) a non-magnetic rare earth oxide compound which is located at the grain boundaries and within the grains of the crystalline R¹_{x-α}R²_{α}Fe_{bal}B_{z-δ}M_{δ}.

11. A nanocomposite permanent magnet comprising a complex of:
(1) crystalline R¹_{x-α}R²_{α}Fe_{bal}Co_{y}B_{z-δ}M_{δ} wherein R is at least one of rare earth elements and M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, α=0-0.1, y=0-0.3, z=0-0.1, and δ=0-0.01, and wherein at least Fe, B and at least one R are present; and
(2) a non-magnetic rare earth oxide compound which is located at the grain boundaries and within the grains of the crystalline R¹_{x-α}R²_{α}Fe_{bal}Co_{y}B_{z-δ}M_{δ}.

12. A nanocomposite permanent magnet comprising a complex of:
(1) crystalline R¹_{x-α}R²_{α}R³_{β}Fe_{bal}B_{z-δ}M_{δ} wherein R is at least one of rare earth elements and M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, α=0-0.1, β=0-0.1, z=0-0.1 and δ=0-0.01, and wherein at least Fe, B and at least one R are present; and
(2) a non-magnetic rare earth oxide compound which is located at the grain boundaries and within the grains of the crystalline R¹_{x-α-β}R²_{α}R³_{β}Fe_{bal}B_{z-δ}M_{δ}.

13. A nanocomposite permanent magnet comprising a complex of:
(1) crystalline R¹_{x-α-β}R²_{α}R³_{β}Fe_{bal}Co_{y}B_{z-δ}M_{δ} wherein R is at least one of rare earth elements and M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=-0-0.3, α=0-0.1, β=0-0.1 y=0-0.3, z=0-0.l and δ=0-0.01, and wherein at least Fe, B and at least one R are present; and
(2) a non-magnetic rare earth oxide compound which is located at the grain boundaries and within the grains of the crystalline R¹_{z-α-β}R²_{α}R³_{β}Fe_{bal}Co_{y}B_{z-δ}M_{δ}.

14. A method for preparing a nanocomposite permanent magnet comprising a complex of
(1) crystalline RₓFe_{bal}B_{z-δ}M_{δ} or RₓFe_{bal}Co_{y}B_{z-δ}M_{δ} wherein R is at least one of rare earth elements, M is selected from the group consisting of Ba, Ca, Mg, Sr, Be, Bi, Cd, Co, Ga, Ge, Hf, In, Al, Si, Mn, Mo, Re, Se, Ta, Nb, Te, Tl, Ti, W, Zr and V, wherein x=0-0.3, y=0-0.3, z=0-0.1 and δ=0-0.01, wherein at least Fe, B and R are present; and
(2) a non-magnetic rare earth oxide compound which is located at the grain boundaries and within the grains of the crystalline RₓFe_{bal}B_{z-δ}M_{δ} or RₓFe_{bal}Co_{y}B_{z-δ}M_{δ}, comprising the following steps:
mixing a precursor, selected from the group consisting of RₓFe_{bal}B_{z-δ}M_{δ} powder and RₓFe_{bal}Co_{y}B_{z-δ}M_{δ} powder, with Zn powder in an organic solvent;
crushing the mixed powders in the solvent under an inert gas atmosphere containing up to 1 volume percent oxygen;
drying the crushed powders in an inert gas;
compacting the dried powders under a magnetic field;
performing a first sintering step wherein the compacted powder is sintered and the Zn is evaporated under pressure in an inert gas, and then allowing the compact to cool, said Zn acting as a catalyst to oxidize R to form R-oxide cubic crystals of R₂O₃ and ROₓ, x=1-2, in epitaxial connection with the tetragonal crystals of RₓFe_{bal}B_{z-δ}M_{δ} or RₓFe_{bal}Co_{y}B_{z-δ}M_{δ}; and
performing a second sintering step to produce a grain boundry composed of amorphous and/or nonocrystalline rare earth oxide phases, and intragranular crystalline rare earth oxide dispersions within the matrix grains.

15. The method of claim 13, wherein the catalyst is a silicate.

16. The method of claim 13, wherein x=0.3 and z=0.1.
